(19) United States
(12) Patent Application Publication
(10) Pub. No.: US 2015/0127393 A1
(43) Pub. Date: May 7, 2015

(54) MONETIZING EMPTY LEGS ON TRANSPORTATION MODES

(71) Applicant: DAL Global Services, LLC, Atlanta, GA (US)

(72) Inventors: CYRIL JOHN TURNER, ATLANTA, GA (US); JOHN JOSEPH DALY, FT. MITCHELL, KY (US); REXFORD MARTIN BEVIS, CINCINNATI, OH (US); BRADLEY TRENT BLETTNER, PARK HILL, KY (US); SCOTT WALTER McCOOL, UNION, KY (US); SCOTT HERRMANN, LOVELAND, OH (US); JOHN JAMES FURNISH, CRESCENT SPRINGS, KY (US); JAMES CRAWFORD MURRAY, III, LEBANON, OH (US)

(73) Assignee: DELTA AIR LINES, INC., Atlanta, GA (US)

(21) Appl. No.: 14/533,368

(22) Filed: Nov. 5, 2014

Related U.S. Application Data
(60) Provisional application No. 61/900,328, filed on Nov. 5, 2013.

(51) Int. Cl. G06Q 10/02

(52) U.S. Cl. CPC G06Q 10/02
USPC 705/5

(57) ABSTRACT

Methods and systems for upgrading passengers from commercial airline flights to private aircraft flights are disclosed. The problem of having a return flight of a private aircraft without revenue generating passengers is solved by selecting a commercial airline flight which best overlaps the return flight of the private aircraft, and offering commercial airline passengers booked on the selected commercial airline flight an opportunity to upgrade to the private aircraft flight. Commercial airline passengers willing to upgrade pay an incremental fee which may be used to offset the cost of the return flight of the private aircraft. Commercial airline passengers may be selected based on their participation in commercial airline marketing programs such as those based on total accumulated miles flown.

### RELATED APPLICATION INFORMATION

The present application claims priority under 35 U.S.C. Section 119(e) to U.S. Provisional Patent Application Ser. No. 61/900,328 filed Nov. 5, 2013 entitled “Monetizing Empty Legs on Transportation Modes” the disclosure of which is incorporated herein by reference in its entirety.

### BACKGROUND OF THE INVENTION

1. Field of the Invention

The present invention relates to airline transportation. More particularly, the invention is directed to methods and systems for upgrading commercial airline passengers to private aircraft flights.

2. Description of the Related Art

Various transportation entities have non-revenue generating segments. As such it is desirable to keep “Empty Legs” to a minimum. The general practice in the Private Jet industry (also called General Aviation or Business Jets), is to fly a paying passenger to their destination and then park the plane until the next assignment location and time is known. The jet is then flown—without revenue—in order to either pick up another revenue generating passenger or return to its home base

A typical example during the winter months is to pick up a passenger in the New York City area and to then fly them to south Florida where they may have a second home. Subsequently an Empty Leg is flown back to the New York City area, only to be flown back to south Florida with another passenger. Considering that Jet A fuel costs more than $5 per gallon retail and, depending upon the jet type, consumes fuel at more than 150 gallons an hour, this practice can be very costly. Typically, fuel represents 30% or more of total costs.

The industry has addressed this huge Empty Leg inefficiency by utilizing 3^{rd} party affiliates to fly customers. For example, if Company A's customer is in New York and their plane is in south Florida, and Company B has an unassigned plane in the New York area, Company A could charter Company B's plane to carry their customer.

While there are numerous computer-based programs and services to help fill Empty Legs, the charter brokering business is still a largely time consuming, manual process. Operators typically call many brokers—many of whom just broker and do not own planes—to negotiate better charter pricing. Pricing itself is a function of how much Empty Leg flying is needed to reposition an aircraft.

FIG. 1 illustrates a selection of a charter airline based on the geographical proximity to the commercial airline route. As shown in FIG. 1, among the key factors in quoting a charter price is the relative distance the affiliate's airplane is from the origination point as well as their final destination relative to the termination point. For example, two affiliates, A and B, are quoting a New York City (“JFK”) to Miami (“MIA”) trip. Affiliate A's distance from A to JFK (the origination point) is further away than Affiliate B's distance from B to JFK. Also Affiliate A's distance from MIA (the termination point) to point A′ is greater than Affiliate B's distance from MIA to point B′. Since Affiliate B's total distance (B-JFK-MIA-B′) is shorter than Affiliate A's (A-JFK-MIA-A′), Affiliate B should be cheaper than Affiliate A. In reality that is not always the case. The reason is the ferry legs, A to JFK and MIA to A′, for example, are not always known by the operator that is requesting the quote. Affiliate B could be opportunistic and charge a higher price. Therefore affiliate lift sourcing can be very expensive.

Despite these efforts to fly customers on affiliates, the industry still has a 30 to 40% Empty Leg inefficiency.

Accordingly, a need exists to improve the coordination of passengers between chartered and commercial airlines.

### SUMMARY OF THE INVENTION

In the first aspect, a computer-implemented method of upgrading passengers from a commercial airline flight to a private aircraft flight is disclosed. The method comprises receiving a notice of departure by a computer-implemented commercial airline reservation system for a private aircraft flight requiring additional passengers, the notice of departure comprising an airport of departure, an airport of arrival, and a date/time of departure. The method further comprises selecting a commercial airline flight by the commercial airline reservation system based on the airport of departure, the airport of arrival, and the time of departure of the private aircraft flight, and identifying one or more commercial airline passengers by the commercial airline reservation system scheduled to depart on the selected commercial airline flight. The method further comprises notifying the identified commercial airline passengers of an offer to upgrade to the private aircraft flight, receiving acceptance of the offer to upgrade to the private aircraft flight from one or more of the notified commercial airline passengers, and upgrading the commercial airline passengers accepting the offer to upgrade to the private aircraft flight.

In a first preferred embodiment, the computer-implemented method of upgrading passengers from a commercial airline flight to a private aircraft flight of claim further comprises generating an itinerary for each of the commercial airline passengers accepting the offer to upgrade of information for the private aircraft flight, and delivering the itinerary to said each of the commercial airline passengers accepting the offer to upgrade. Selecting a commercial airline flight by the commercial airline reservation system preferably further comprises selecting commercial airline flights scheduled to depart before the time of departure of the private aircraft flight. Identifying one or more commercial airline passengers preferably further comprises identifying one or more commercial airline passengers based on the commercial airline passenger membership of frequent flier tiers. Selecting a commercial airline flight preferably further comprises selecting a first commercial airline flight for a first flight segment from the airport of departure to a hub of the commercial airline flight, and selecting a second commercial airline flight from the hub to the airport of arrival.

The method preferably further comprises releasing the commercial airline flights seats of the commercial airline passengers accepting the offer to upgrade back into an inventory of available seats of the commercial airline flight. The method preferably further comprises receiving an offer to purchase the commercial airline flights seats of the commercial airline passengers accepting the offer to upgrade by another passenger, and receiving payment by said another passenger to purchase the commercial airline flights seats of the commercial airline passengers accepting the offer to upgrade. The payment to purchase the commercial airline flights seats is preferably an original price of the seat of the commercial airline passengers accepting the offer to upgrade.

The method preferably further comprising collecting an incremental fee from the commercial airline passengers accepting the offer to upgrade. The method preferably further comprises distributing the incremental fees from the commercial airline passengers accepting the offer to upgrade to the private aircraft operator operating the private aircraft flight. The computer-implemented commercial airline reservation system preferably further comprises a reservation system for a plurality of airlines, the reservation system for the plurality of airlines further configured to interact with one or more private aircraft operators.

In a second aspect, a computer-implemented method of upgrading passengers from a commercial airline flight to a private aircraft flight is disclosed. The method comprises employing one or more computer systems for receiving a notice of departure for a private aircraft flight requiring additional passengers, the notice of departure comprising an airport of departure, an airport of arrival, and a time of departure, and selecting a commercial airline flight based on the airport of departure, the airport of arrival, and the time of departure of the private aircraft flight. The method further comprises identifying one or more commercial airline passengers scheduled to depart on the selected commercial airline flight, and notifying the identified commercial airline passengers of an offer to upgrade to the private aircraft flight. The method further comprises receiving acceptance of the offer to upgrade to the private aircraft flight from one or more of the notified commercial airline passengers, and upgrading the commercial airline passengers accepting the offer to upgrade to the private aircraft flight.

In a second preferred embodiment, the method further comprises generating an itinerary for each of the commercial airline passengers accepting the offer to upgrade of information for the private aircraft flight, and delivering the itinerary to said each of the commercial airline passengers accepting the offer to upgrade. Selecting a commercial airline flight preferably further comprises selecting commercial airline flights scheduled to depart before the time of departure of the private aircraft flight. Identifying one or more commercial airline passengers preferably further comprises identifying one or more commercial airline passengers based on the commercial airline passenger membership of frequent flier tiers. Selecting a commercial airline flight further preferably comprises selecting a first commercial airline flight for a first flight segment from the airport of departure to a hub of the commercial airline flight, and selecting a second commercial airline flight from the hub to the airport of arrival.

The method preferably further comprises releasing the commercial airline flights seats of the commercial airline passengers accepting the offer to upgrade back into an inventory of available seats of the commercial airline flight. The method preferably further comprises receiving an offer to purchase the commercial airline flights seats of the commercial airline passengers accepting the offer to upgrade by another passenger, and receiving payment by said another passenger to purchase the commercial airline flights seats of the commercial airline passengers accepting the offer to upgrade. The payment to purchase the commercial airline flights seats is preferably an original price or greater price of the seat of the commercial airline passengers accepting the offer to upgrade. The method preferably further comprising collecting an incremental fee from the commercial airline passengers accepting the offer to upgrade.

In a third aspect, a system for upgrading passengers from a commercial airline flight to a private aircraft flight is disclosed. The system comprises a private aircraft operator computer system comprising a private aircraft controller, and a private aircraft database in communication with the private aircraft controller. The system further comprises a network communicating with the private aircraft operator computer system and a commercial airline system. The system further comprises the commercial airline computer system comprising an airline controller, and a commercial airline database in communication with the airline controller. The airline controller is configured to receive a notice of departure for a private aircraft flight requiring additional passengers, the notice of departure comprising an airport of departure, an airport of arrival, and a time of departure, select a commercial airline flight of a commercial airline flight based on the airport of departure, the airport of arrival, and the time of departure of the private aircraft flight, and identify one or more commercial airline passengers scheduled to depart on the selected commercial airline flight.

In a third preferred embodiment, the system further configured to notify the identified commercial airline passengers of an offer to upgrade to the private aircraft flight, receive acceptance of the offer to upgrade to the private aircraft flight from one or more of the notified commercial airline passengers, and upgrade the commercial airline passengers accepting the offer to upgrade to the private aircraft flight.

These and other features and advantages of the invention will become more apparent with a description of preferred embodiments in reference to the associated drawings.

### DESCRIPTION OF THE DRAWINGS

FIG. 1 illustrates a selection of an aircraft charter flight based on the geographical proximity to the commercial airline route.

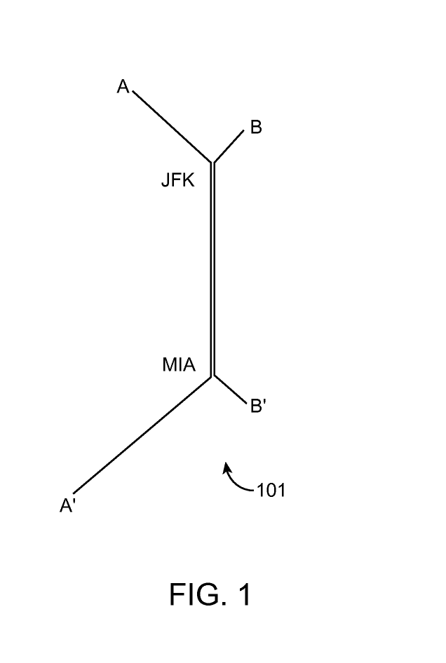

FIG. 2 is a schematic, block diagram of a process for selecting commercial airline passengers for a private aircraft charter flight.

FIG. 3 is a schematic, block diagram of a computer system networking a private aircraft company with a commercial airline in one or more embodiments.

FIG. 4 depicts an exemplary process for selecting commercial airline flights and commercial airline passengers for a private aircraft charter flight.

FIG. 5 depicts an exemplary process for a commercial airline passenger in one or more embodiments.

### DETAILED DESCRIPTION OF THE PREFERRED EMBODIMENTS

The private jet solution involves a partnership with a commercial airline. Suppose that a private jet needs to reposition from Miami to New York. The commercial airline reservation system is checked for passengers scheduled to fly between that city pair. The private jet company (i.e., a chartered airline or a private aircraft operator) then offers commercial passengers an upgrade to private jet travel in exchange for a fee incremental to what they already paid for their commercial seat. Subsequently the commercial seats that have been vacated are then released back into reservations inventory and can be resold at 100% margin.

Since commercial airlines have advance bookings and fly large planes, there are typically a large number of customers flying between city pairs. There are even more eligible customers on flights flown to and from hubs—Atlanta, for example. Using the Miami to New York empty leg as an example, commercial airline passengers flying on the Miami to Atlanta commercial segment would be offered an opportunity to upgrade to a private jet on that segment. Subsequently, passengers on the Atlanta to New York commercial segment would also be eligible for a private jet upgrade. As used herein, an “Empty Leg” may refer to the non-revenue producing return portion of a one-way private airline chartered flight. Alternatively, commercial airline passengers who are currently scheduled to make a connection through Atlanta on their Miami to New York travel may be offered the opportunity to go non-stop on the private jet, hence increasing the value proposition to the consumer.

Yet even more commercial airline passengers can be identified on subsequent commercial flights. If the private jet is scheduled to leave at 10 a.m. for an Empty Leg flight, commercial flights scheduled for 10 a.m., 11 a.m., and noon departures can be sourced for passengers that may be interested in upgrading to private. This effectively pulls commercial passengers to an earlier departure time on the private flight. Since most people have not flown private and will now be able do so at a more affordable rate, they will be willing adjust their schedules accordingly.

Upgrading commercial airline passengers to private jets will improve the overall airline flying experience. Not only will upgraded passengers get an improved flying experience that they otherwise could not afford, in the case of vacated first class seats, an upgrade opportunity for coach seat passengers is made available as well.

Revenue management aspects can be applied. For example, the pricing could be based upon a rate per mile flown, wherein New York to Los Angeles would be more expensive than New York to Chicago. Pricing could also be based upon supply and demand. In cases of excessive empty leg availability, lower prices would apply, and vice versa.

There could also be collaboration among the industries. Competing commercial airlines could aggregate passenger reservation systems. This would also leverage more hub flights, thereby maximizing profit opportunities. Similarly, private jet companies could aggregate. The entire industry has the empty leg problem. About 30-40% of private aviation flights are empty legs. With Jet A fuel costing more than $5 per gallon at more a 150 gallon per hour burn rate, this is costly. More than 30% of the cost structure is fuel costs. Aggregating in this manner will increase overall efficiencies.

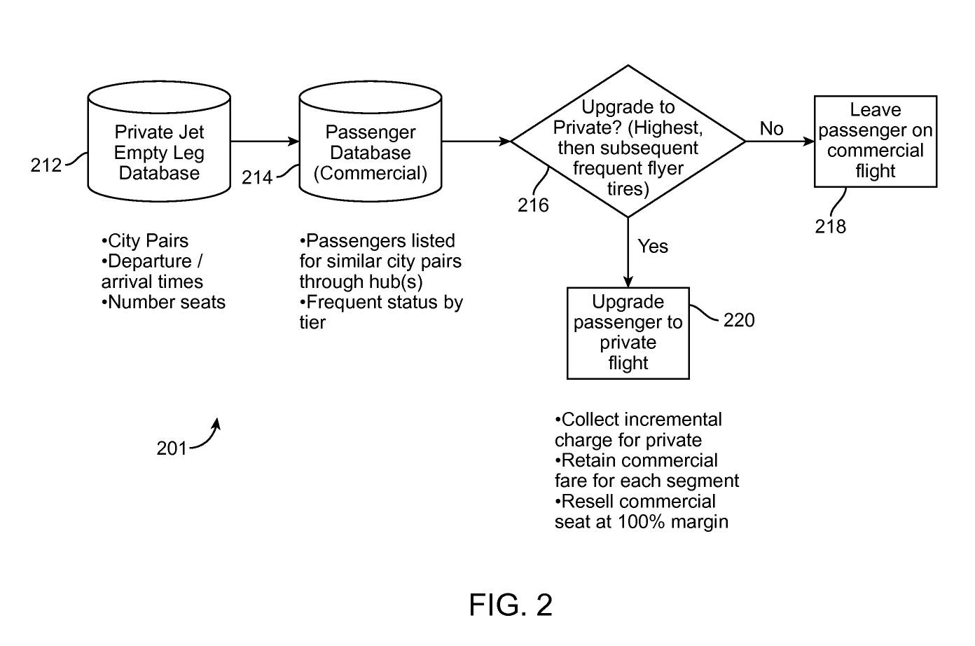

FIG. 2 is a schematic, block diagram of a process 201 for selecting commercial airline passengers for a private aircraft charter flight. The process 201 employs a Private Jet Empty Leg Database 212 for an aircraft charter company and a Passenger Database 214 for a commercial airline. The Private Jet Empty Leg Database 212 may include information for city pairs, departure and arrival times, and the number of seats available on a private aircraft. The Passenger Database 214 includes information regarding the commercial airline passengers listed for similar city pairs through one or more hubs, and the frequent flier status by tier. Based on the information in the databases 212 and 214, the selection of commercial airline passengers is made to determine which commercial airline passengers are eligible to be upgraded to a private aircraft (step 216). The selection process may include selecting passengers based on the frequent flier tiers of each of the passengers. Commercial airline passengers not selected for an opportunity to fly on a private aircraft remain on the commercial flight (step 218). Commercial airline passengers selected are upgraded to travel on the private flight (step 220). The incremental charge of the private aircraft flight is collected from the selected passengers. The commercial airline retains the commercial fare for each segment. The commercial airline also has the opportunity to resell the commercial seat at a 100% margin.

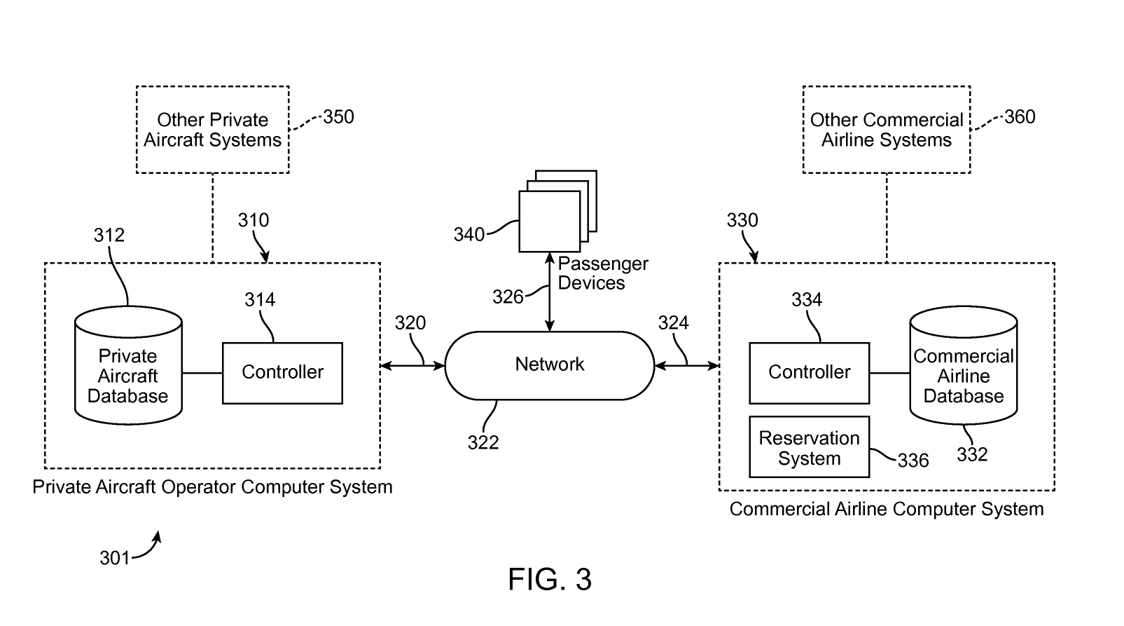

FIG. 3 is a schematic, block diagram of a computer system 301 networking a private aircraft operator computer system 310 with a commercial airline computer system 330 in one or more embodiments. A network 322 facilitates the communication between the private aircraft operator computer system 310 and the commercial airline computer system 330. The network 322 communicates to the private aircraft operator computer system 310 via communication routes 320, and to the commercial airline computer system 330 via communication routes 324. The private aircraft operator computer system 310 comprises a private aircraft controller 314 and a private aircraft database 312 in communication with the private aircraft controller 314. The commercial airline computer system 330 comprises a commercial airline controller 334 and a commercial airline database 332 in communication with the airline controller 334. In one or more embodiments, the commercial airline computer system 330 further comprises a commercial airline reservation system 336.

In one or more embodiments, the computer system 301 further comprises one or more passenger devices 340 configured for communicating to the network 322 via communication route 326. In one or more embodiments, the passenger devices 322 may comprise computers, tablets, smart phones, or telephones. In one or more embodiments, the passenger devices 340 may communicate via email, text, voicemail, Internet, phone, or other communication means.

In one or more embodiments, the computer system 301 may further comprise other private aircraft computer systems 350 and/or other commercial airline systems 360 which may be employed for services which aggregate multiple private aircraft operators or multiple commercial airlines

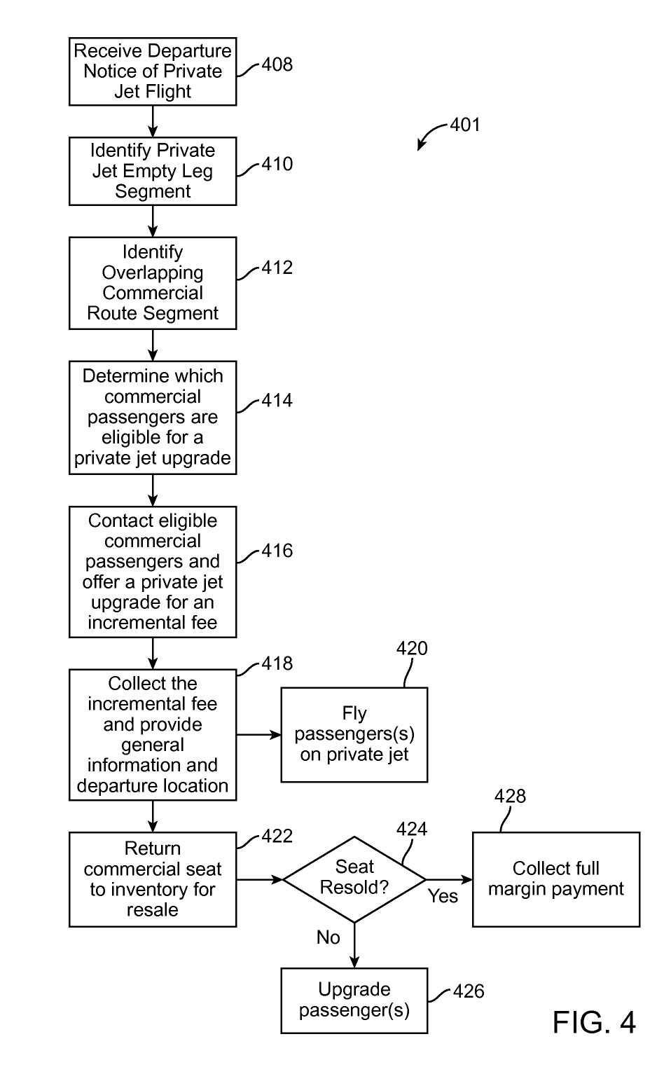

FIG. 4 depicts an exemplary process 401 for selecting commercial airline flights and commercial airline passengers for a private aircraft charter service. In one or more embodiments, a computer-implemented commercial airline reservation system 336 performs one or more of the steps listed in the exemplary process 401. In one or more embodiments, one or more computer-implemented processors residing on the private aircraft computer system 314 or the commercial airline computer system 334 performs one or more of the steps listed in the exemplary process 401.

As shown in FIG. 4, the process 401 starts with receiving notice of departure of a private aircraft flight (step 408). The Empty Leg segments are identified (step 410). The associated city pair is identified which can either overlap commercial airports (Miami and New York's JFK) or be nearby private airports (West Palm Beach and New York's Teterboro), or a combination of both (step 412).

With an established private jet Empty Leg departure time, the commercial reservation system 336 is then queried to find potential passengers to upgrade (step 414). Most airlines would want to first offer the private jet upgrade opportunity to their top customers.

Identified customers are then contacted via email, text, voicemail, or phone for example, and are offered an “upgrade to private” for an incremental charge (step 416). The sequence of the offering the upgrade to private to the commercial airline passengers could be based on the highest tier frequent flyer, then the subsequent frequent flyer tiers in descending sequence, and then full fare customers. In one or more embodiments, a frequent flier program may comprise multiple tiers of frequent flier members. If the available private jet seats are not yet filled, the airline may choose to make the upgrade offer to non-frequent flyers, perhaps based upon highest priced commercial ticket to the lowest. This sequence is commonly referred to as boarding priority or boarding status, and mimics the priority given for upgrades on commercial flights.

For those customers that elect to upgrade to private, the commercial fare for that segment is retained by the airline and the seat placed back into inventory for resale—at nearly 100% profit margin (step 422). If, at step 424, the seat is resold, the commercial airline collects the full margin payment (step 428). Otherwise, commercial passengers may upgrade other passengers (step 426).

The private jet company would receive the incremental upgrade fee to offset their costs, and receipt of payment and contract processing would be handled in accordance with applicable regulations (step 418). The selected passengers are flown in a private jet (step 420).

In one or more embodiments, a computer-implemented method of upgrading passengers from a commercial airline flight to a private aircraft flight comprises receiving a notice of departure for a private aircraft flight requiring additional passengers (FIG. 4, step 408). In one or more embodiments, the notice of departure comprises an airport of departure, an airport of arrival, and a time of departure. In one or more embodiments, a computer-implemented commercial airline reservation system 336 receives and processes the notice of departure for a private aircraft flight. In an embodiment, one or more computer-implemented processors residing on the private aircraft computer system 314 or the commercial airline computer system 334 receives and processes the notice of departure for a private aircraft flight.

In one or more embodiments, an identification of the private aircraft flight empty leg segments is identified (FIG. 4, step 410) by the commercial airline reservation system 336, the commercial airline computer system controller 334, or the private aircraft computer system controller 314.

In one or more embodiments, an identification of the overlapping commercial route segment (step 412) and the selecting of a commercial airline flight are performed by the commercial airline reservation system 336. In one or more embodiments, the identification of the overlapping commercial route segment (step 412) and the selecting of a commercial airline flight are performed by the commercial airline computer system controller 334, or the private aircraft computer system controller 314.

In one or more embodiments, the determination or the identification of one or more commercial airline passengers (step 414) is performed by the commercial airline reservation system 336. In one or more embodiments, the determination or the identification of one or more commercial airline passengers is performed by the commercial airline computer system controller 334, or the private aircraft computer system controller 314.

In one or more embodiments, a computer-implemented commercial airline reservation system 336 contacts and notifies the identified commercial airline passengers of an offer to upgrade to the private aircraft flight (step 416). In one or more embodiments, one or more computer-implemented processors residing on the private aircraft computer system 314 or the commercial airline computer system 334 contacts and notifies the identified commercial airline passengers of an offer to upgrade to the private aircraft flight.

In one or more embodiments, a computer-implemented commercial airline reservation system 336 receives acceptance of the offer to upgrade to the private aircraft flight from one or more of the notified commercial airline passengers, and upgrades the commercial airline passengers accepting the offer to upgrade to the private aircraft flight. In one or more embodiments, one or more computer-implemented processors residing on the private aircraft computer system 314 or the commercial airline computer system 334 receives acceptance of the offer to upgrade to the private aircraft flight from one or more of the notified commercial airline passengers, and upgrades the commercial airline passengers accepting the offer to upgrade to the private aircraft flight.

In cases where filled Empty Leg flights are flown through a hub airport, the above process is repeated for the 2^{nd} segment. Ground transportation would be arranged for passengers on the 1^{st} segment, transporting from the FBO (Fixed Base Operation, or private airport building) to the front of the commercial airport. They would go through security and then on to commercial connecting flights.

Passengers on the 2^{nd} private segment would be met at the front of the commercial airport and transported to the nearby FBO. (Note no security screening required when flying private.)

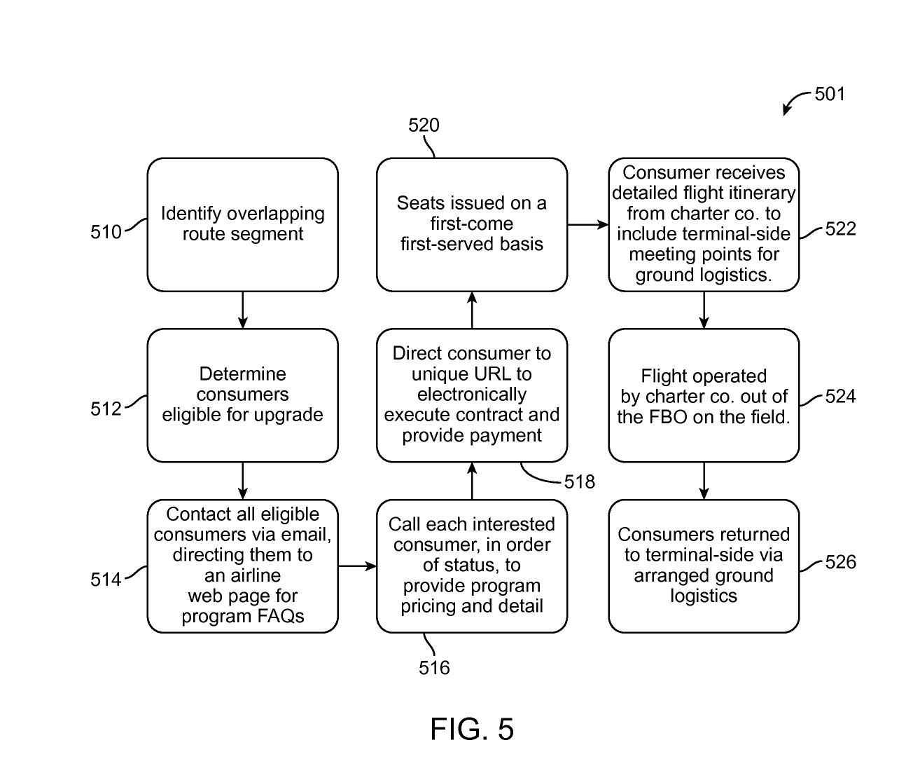

FIG. 5 depicts an exemplary process 501 for a commercial airline consumer in one or more embodiments. An overlapping route segment for a commercial airline flight that corresponds to the charter air flight is identified (step 510). The commercial airline consumers who are eligible for an upgrade to the private air charter flight is determined (step 512). All of the eligible commercial airline consumers are contact via email for example which directs the eligible consumers to a commercial airline webpage having the frequently asked questions (step 514). Each of the interested consumers, in order of status, is contacted to provide program pricing and details (step 516). Each consumer is directed to a unique webpage URL to electrically execute contract and provide payment (step 518). The seats on the air charter flight are issued on a first come, first serve basis (step 520), or based upon the frequent flyer status. The consumers receive a detailed flight itinerary from the private air charter company which includes terminal-side meeting points for ground logistics (step 522). The flight is operated by the private air charter company out of the Fixed Base Operation (“FBO”) (step 524). The consumers are then returned to the terminal-side via arranged ground logistics (step 526).

Although the invention has been discussed with reference to specific embodiments, it is apparent and should be understood that the concept can be otherwise embodied to achieve the advantages discussed. The preferred embodiments above have been described primarily as methods and systems for upgrading commercial airline passengers to private aircraft flights. In this regard, the foregoing description of the methods and systems for upgrading commercial airline passengers to private aircraft flights are presented for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A computer-implemented method of upgrading passengers from a commercial airline flight to a private aircraft flight, the method comprising:
receiving a notice of departure by a computer-implemented commercial airline reservation system for a private aircraft flight requiring additional passengers, the notice of departure comprising an airport of departure, an airport of arrival, and a date and a time of departure;
selecting a commercial airline flight by the commercial airline reservation system based on the airport of departure, the airport of arrival, and the date and the time of departure of the private aircraft flight;
identifying one or more commercial airline passengers by the commercial airline reservation system scheduled to depart on the selected commercial airline flight;
notifying the identified commercial airline passengers of an offer to upgrade to the private aircraft flight;
receiving acceptance of the offer to upgrade to the private aircraft flight from one or more of the notified commercial airline passengers; and,
upgrading the commercial airline passengers accepting the offer to upgrade to the private aircraft flight.

2. The computer-implemented method of upgrading passengers from a commercial airline flight to a private aircraft flight of claim 1, the method further comprising:
generating an itinerary for each of the commercial airline passengers accepting the offer to upgrade of information for the private aircraft flight; and,
delivering the itinerary to said each of the commercial airline passengers accepting the offer to upgrade.

3. The computer-implemented method of upgrading passengers from a commercial airline flight to a private aircraft flight of claim 1, wherein selecting a commercial airline flight by the commercial airline reservation system further comprises selecting commercial airline flights scheduled to depart before the time of departure of the private aircraft flight.

4. The computer-implemented method of upgrading passengers from a commercial airline flight to a private aircraft flight of claim 1, wherein identifying one or more commercial airline passengers further comprises identifying one or more commercial airline passengers based on the commercial airline passenger membership of frequent flier tiers.

5. The computer-implemented method of upgrading passengers from a commercial airline flight to a private aircraft flight of claim 1, wherein selecting a commercial airline flight further comprises selecting a first commercial airline flight for a first flight segment from the airport of departure to a hub of the commercial airline flight, and selecting a second commercial airline flight from the hub to the airport of arrival.

6. The computer-implemented method of upgrading passengers from a commercial airline flight to a private aircraft flight of claim 1, the method further comprising releasing the commercial airline flights seats of the commercial airline passengers accepting the offer to upgrade back into an inventory of available seats of the commercial airline flight.

7. The computer-implemented method of upgrading passengers from a commercial airline flight to a private aircraft flight of claim 6, the method further comprising:
receiving an offer to purchase the commercial airline flights seat of the commercial airline passenger accepting the offer to upgrade by another passenger;
receiving payment by said another passenger to purchase the commercial airline flights seat of the commercial airline passenger accepting the offer to upgrade, wherein the payment to purchase the commercial airline flights seat is an original price or greater price of the seat of the commercial airline passenger accepting the offer to upgrade.

8. The computer-implemented method of upgrading passengers from a commercial airline flight to a private aircraft flight of claim 1, the method further comprising collecting an incremental fee from the commercial airline passengers accepting the offer to upgrade.

9. The computer-implemented method of upgrading passengers from a commercial airline flight to a private aircraft flight of claim 8, the method further comprising distributing the incremental fees from the commercial airline passengers accepting the offer to upgrade to the private aircraft operator operating the private aircraft flight.

10. The computer-implemented method of upgrading passengers from a commercial airline flight to a private aircraft flight of claim 1, wherein the computer-implemented commercial airline reservation system further comprises a reservation system for a plurality of airlines, the reservation system for the plurality of airlines further configured to interact with one or more private aircraft operators.

11. A computer-implemented method of upgrading passengers from a commercial airline flight to a private aircraft flight, the method comprising:
employing one or more computer systems for:
receiving a notice of departure for a private aircraft flight requiring additional passengers, the notice of departure comprising an airport of departure, an airport of arrival, and a time of departure;
selecting a commercial airline flight based on the airport of departure, the airport of arrival, and the time of departure of the private aircraft flight;
identifying one or more commercial airline passengers scheduled to depart on the selected commercial airline flight;
notifying the identified commercial airline passengers of an offer to upgrade to the private aircraft flight;
receiving acceptance of the offer to upgrade to the private aircraft flight from one or more of the notified commercial airline passengers; and,
upgrading the commercial airline passengers accepting the offer to upgrade to the private aircraft flight.

12. The computer-implemented method of upgrading passengers from a commercial airline flight to a private aircraft flight of claim 11, the method further comprising:
generating an itinerary for each of the commercial airline passengers accepting the offer to upgrade of information for the private aircraft flight; and,
delivering the itinerary to said each of the commercial airline passengers accepting the offer to upgrade.

13. The computer-implemented method of upgrading passengers from a commercial airline flight to a private aircraft flight of claim 11, wherein selecting a commercial airline flight further comprises selecting commercial airline flights scheduled to depart before the time of departure of the private aircraft flight.

14. The computer-implemented method of upgrading passengers from a commercial airline flight to a private aircraft flight of claim 11, wherein identifying one or more commercial airline passengers further comprises identifying one or more commercial airline passengers based on the commercial airline passenger membership of frequent flier tiers.

15. The computer-implemented method of upgrading passengers from a commercial airline flight to a private aircraft flight of claim 11, wherein selecting a commercial airline flight further comprises selecting a first commercial airline flight for a first flight segment from the airport of departure to a hub of the commercial airline flight, and selecting a second commercial airline flight from the hub to the airport of arrival.

16. The computer-implemented method of upgrading passengers from a commercial airline flight to a private aircraft flight of claim 11, the method further comprising
releasing the commercial airline flights seats of the commercial airline passengers accepting the offer to upgrade back into an inventory of available seats of the commercial airline flight.

17. The computer-implemented method of upgrading passengers from a commercial airline flight to a private aircraft flight of claim 16, the method further comprising:
receiving an offer to purchase the commercial airline flights seats of the commercial airline passengers accepting the offer to upgrade by another passenger;
receiving payment by said another passenger to purchase the commercial airline flights seats of the commercial airline passengers accepting the offer to upgrade, wherein the payment to purchase the commercial airline flights seats is an original price of the seat of the commercial airline passengers accepting the offer to upgrade.

18. The computer-implemented method of upgrading passengers from a commercial airline flight to a private aircraft flight of claim 11, the method further comprising collecting an incremental fees from the commercial airline passengers accepting the offer to upgrade.

19. A system for upgrading passengers from a commercial airline flight to a private aircraft flight, the system comprising:
a private aircraft operator computer system comprising:
a private aircraft controller;
a private aircraft database in communication with the private aircraft controller;
a network communicating with the private aircraft operator computer system and a commercial airline system; and
the commercial airline computer system comprising:
an airline controller; and,
a commercial airline database in communication with the airline controller, wherein the airline controller is configured to:
receive a notice of departure for a private aircraft flight requiring additional passengers, the notice of departure comprising an airport of departure, an airport of arrival, and a time of departure;
select a commercial airline flight of a commercial airline flight based on the airport of departure, the airport of arrival, and the time of departure of the private aircraft flight;
identify one or more commercial airline passengers scheduled to depart on the selected commercial airline flight;

20. A system for upgrading passengers from a commercial airline flight to a private aircraft flight of claim 19, the system further configured to:
notify the identified commercial airline passengers of an offer to upgrade to the private aircraft flight;
receive acceptance of the offer to upgrade to the private aircraft flight from one or more of the notified commercial airline passengers; and,
upgrade the commercial airline passengers accepting the offer to upgrade to the private aircraft flight.
